(19) United States
(12) Patent Application Publication
(10) Pub. No.: US 2007/0162677 A1
(43) Pub. Date: Jul. 12, 2007

(54) Hot-plug extension device and a display having the hot-plug extension device

(75) Inventors: Feng-Shii Tsai, Hsin Tien City (TW); Sy-Shang Chen, Hsin Tien City (TW); Ken-Su Chen, Hsin Tien City (TW); Alex Leng, Hsin Tien City (TW)

Correspondence Address: COOPER & DUNHAM, LLP, 1185 AVENUE OF THE AMERICAS, NEW YORK, NY, 10036, US

(73) Assignee: Chuntex Electronic Co., Ltd.

(21) Appl. No.: 11/326,654

(22) Filed: Jan. 6, 2006

(51) Int. Cl. G06F 13/00

(52) U.S. Cl. 710/302

(57) ABSTRACT

An LCD display capable of connection to a hot-plug extension device has a microprocessor that includes a detecting port, a signal-out pin and a power pin. The detecting port is connected to at least two detecting switches. A power switch is connected to the signal-out pin and the power pin. The two detecting switches and the power switch are connected to the hot-plug extension device. The microprocessor judges if the extension device is connected to the display correctly using the detecting switch and decides if the power is allowed to activate the extension device.

### BACKGROUND OF THE INVENTION

1. Field of the Invention

The present invention relates to a hot-plug extension device for a display and, and particularly relates to a hot-plug extension device that can be coupled to a display safely and provide extension functions for the display.

2. Description of the Related Art

Display is developed from CRT (Cathode Ray Tube) to LCD (Liquid Crystal Display). As the LCD display develops, manufactures also add different equipment in the display to extend its functions ,for example, a speaker and a TV signal receiving port.

However, the extension ability of the LCD display is limited by its built-in equipment.

Therefore, the invention provides a hot-plug extension device for a display to mitigate or obviate the aforementioned problems.

### SUMMARY OF THE INVENTION

The main objective of the present invention is to provide a hot-plug extension device for a display to provide more supplementary functions.

Another objective of the present invention is to provide an LCD display capable of safely connecting the foregoing hot-plug extension device.

The LCD display has a microprocessor with a detecting pin, a signal-out pin and a power pin, the detecting pin connected to at least two detecting switches; a power switch is connected to the signal-out pin and the power pin; and the two detecting switches and the power switch are connected to the hot-plug extension device.

The microprocessor in the LCD display determines if the extension device is connected to the LCD display correctly, then the power in the LCD display activates the extension device to avoid any damages resulted from abnormal power supply. Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a hot-plug extension device of a first embodiment in accordance with this invention, wherein the hot-plug extension device is a TV box;

FIG. 2 is a circuit diagram of a display being connected to the hot-plug extension device in accordance with this invention; and

FIG. 3 is another embodiment of the display being connected to the extension device in accordance with the present invention.

### DETAILED DESCRIPTION OF THE PREFERRED EMBODIMENT

A hot-plug extension device for a display in accordance with the present invention may be a set top box, a TV box, a card reader, or a multimedia player etc., which provides extension functions to the display.

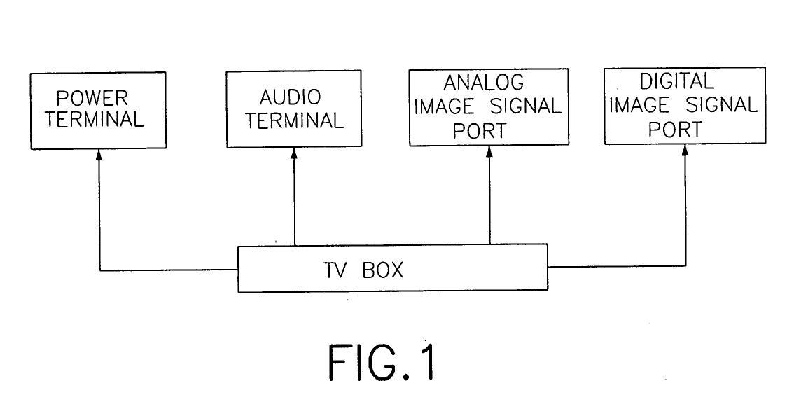

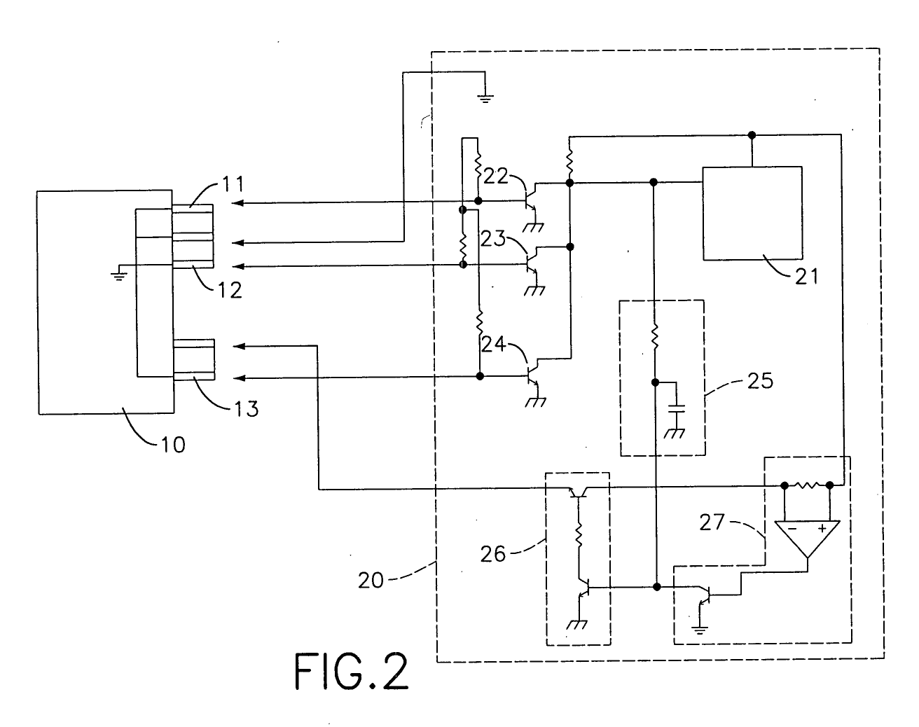

With reference to FIGS. 1-2, the hot-plug extension device (10) is a TV box in this embodiment as an example. The hot-plug extension device (10) to be connected to an LCD display (20) includes a power terminal, an audio terminal, an analog image signal port(D-SUB), a digital image signal port.

If the extension device (10) is incorrectly connected to the LCD display (20) or not reliably in contact with the LCD device (20), the connection can cause a possible damage to the extension device (10) or the display (20). Therefore, detecting pins are proposed in this invention to judge whether or not the connection between the extension device (10) and the LCD display (20) is correct. In detail, the detecting pins can be optionally formed in the extension device (10). The extension device (10) has a circuit board with multiple pins thereon. These pins comprise functions of signal transmission, power supplying, detecting, etc. The detecting pins can be formed on two proximal ends or in a middle of the circuit board.

In FIG. 2, the extension device (10) has three detecting pins (11), (12), and (13) in addition to the standard pins. The display (20) has a microprocessor (21), which has a detecting port, a power pin (VCC), and a signal out pin.

The detecting terminal of the microprocessor (21) is connected to three transistors that server as three detecting switches (22), (23), and (24). Bases of the three transistors are respectively connected to the three detecting pins (11), (12) and (13). Emitters of all the transistors are coupled together to a ground, and collectors of all the transistors are connected to the detecting port of the microprocessor (21). Furthermore, the detecting port of the microprocessor (21) is connected to a delay circuit (25) with a delay time constant composed of resistors and capacitors. The delay circuit (25) is connected to a power switch (26). The power switch (26) composed of two transistors and a resistor is to be connected to the power pins in the extension device (10).

The power pin (VCC) is connected to the power switch (26) through an over current protecting circuit (27), and the power pin (VCC) is also connected to the three detecting switches (22), (23), and (24).

When the three detecting pins (11), (12) and (13) are coupled to the corresponding detecting switches (22), (23), and (24), the detecting port of the microprocessor (21) determines if the connection is correct based on the voltage potential. If the connection is correct, the microprocessor (21) outputs a driving signal to the delay circuit (25) from the signal-out pin. After several milliseconds (depending on the delay time constant), the power switch (26) is activated, and the power in the display (20) is allowed to be transmitted to the extension device (10), served as an operating voltage of the extension device (10).

In contrast, if the detecting pins (11), (12) and (13) are connected incorrectly to the LCD display (20), the detecting port of the microprocessor (21) cannot detect a right potential. Accordingly, no driving signal is output to the delay circuit (25). The extension device (10) will not be damaged due to the wrong connection.

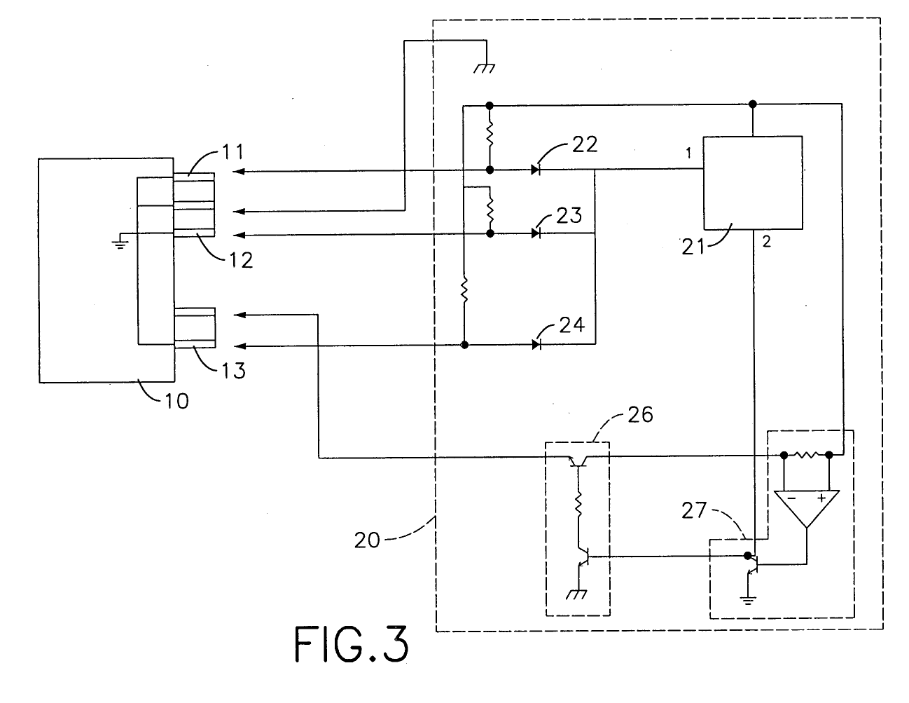

FIG. 3 shows another embodiment of this invention, the detecting switches (22), (23) and (24) are formed by three diodes, and the delay function is performed by the microprocessor (21), i.e. the delay circuit (25) is omitted. The microprocessor (21) sets a delay time and controls the power switch (26) directly. If the extension device (10) is connected correctly, after the delay time, the microprocessor (21) will give a driving signal to the power switch (26) and provide operating voltage to the extension device (10).

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LCD display capable of connecting to a hot-plug extension device, the LCD display comprising:
a microprocessor having a detecting port, a signal-out pin and a power pin, the detecting pin connected to at least two detecting switches; and
a power switch connected to the signal-out pin and the power pin;
wherein the at least two detecting switches and the power switch are to be connected to the hot-plug extension device, and whether the LCD display correctly connects to the hot-plug extension device is determined using the at least two detecting switches.

2. The LCD display as claimed in claim 1, wherein the signal-out pin is connected to the power switch through a delay circuit.

3. The LCD display as claimed in claim 1, wherein the power pin of the microprocessor is connected to the power switch through a over current protecting circuit.

4. The LCD display as claimed in claim 3, wherein the detecting switches are formed by transistors.

5. The LCD display as claimed in claim 3, wherein the detecting switches are formed by diodes.

6. The LCD display as claimed in claim 4, wherein emitters of the transistors are coupled to a ground, collectors of the transistors are connected to the detecting port of the microprocessor.

7. The LCD display as claimed in claim 2, wherein the delay circuit comprises a resistor and a capacitor.

8. An hot-plug extension device for the LCD display as claimed in claim 1, the hot-plug extension device comprising:
a circuit with multiple pins formed thereon to be connected to the LCD display, the multiple pins comprising at least two detecting pins, wherein the detecting pins are connected to the detecting switches of the LCD display to change a voltage potential of the detecting port.
